(19) United States
(12) Patent Application Publication
(10) Pub. No.: US 2006/0210929 A1
(43) Pub. Date: Sep. 21, 2006

(54) Photosensitive composition and forming process of structured material using the composition

(75) Inventor: Kenji Yamada, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/373,971

(22) Filed: Mar. 14, 2006

(30) Foreign Application Priority Data
Mar. 15, 2005 (JP) 2005-073255 (PAT.

(51) Int. Cl. C08G 77/04; G03C 5/00

(52) U.S. Cl. 430/311; 528/34

(57) ABSTRACT

The invention provides a photosensitive composition for forming a highly heat-resistant pattern of a micro phase separation structure. The photosensitive composition comprises: (A) a block copolymer containing a segment composed of an alkoxysilyl-group-containing monomer as a repeating unit, and (B) a photosensitive decomposition agent. The polydispersity index (Mw/Mn) of the block copolymer is 1.8 or lower.

### BACKGROUND OF THE INVENTION

1. Field of the Invention

The present invention relates to a photosensitive composition and a production process of a structured material formed of an inorganic substance, in which in a pattern formed by a photolithographic process using the photosensitive composition, a micro phase separation structure pattern of a block copolymer having a lower dimension is formed. This structured material is expected to apply to low-dielectric constant insulation films.

2. Related Background Art

The impartment of higher performance to LSIs has become great driving force for the rapid development of speeding-up, impartment of higher function, miniaturization and weight saving of electronic equipment in recent years. Semiconductor integrated circuits (semiconductor ICs) developed as core technologies of transistors integrated on a chip in LSI make a great progress. In these semiconductor ICs, sophisticated microprocessing techniques are required. Although a lithographic technique that is a typical microprocessing technique has fulfilled a great role in the realization of larger scale LSIs higher in integration in that it can satisfy high-density integration from the viewpoint of throughput because of single-step exposure, a physical limitation (from 100 nm down to several tens nm) of a line width in a photolithographic technique is pointed out. As techniques coping with this limitation, techniques such as immersion exposure and electron beam lithography have been developed. However, such techniques increase production costs such as plant cost and operation cost as the number of steps in microprocessing increases, or the size of the microprocessing becomes smaller, and a practical deadlock is recognized even from the viewpoint of working speed.

As a process for breaking through the limitation of the lithographic techniques, is investigated a microstructure-forming technique using self-organization of a block copolymer. As well known in the field of polymer blends and polymer alloys, polymers different from each other are generally incompatible with each other, and a mixture thereof and a block copolymer take a phase separation state. In general, the scale of phase separation in a polymer blend is a macroscale (macro phase separation) as several micrometers or longer, whereas the scale of phase separation in a block copolymer with respective components linked by a covalent bond is regulated by the length of a block, so that it stably gives a micro and homogeneous phase separation state of a nanometer-size.

A micro phase separation structure can be controlled in a wide range by using block copolymers of various molecular structures. For example, molar fractions of repeating units in a block A and a block B are changed, whereby the phase separation structure between the block A and the block B can be changed from a sea-island structure to a lamellar structure. Alternatively, the molecular weights of the block A and the block B are changed, whereby the domain size of the phase separation structure can be controlled.

Examples of the formation of a pattern using such a micro phase separation structure of block copolymers include the following examples. A process for forming a pattern on a silicon nitride using a micro phase separation structure of a polystyrene (PS)-polybutadiene (PB) block copolymer as a template by means of a reactive ion etching (RIE) method is reported (Science, Vol. 276, p. 1401 (1997)). A process for forming a nano structure composed of an inorganic component from a micro phase separation structure of a coating film of a composition comprising a polyisoprene (PI)-polyethylene oxide (PEO) block copolymer, a silane coupling agent and a metal alkoxide is also reported (Advanced Materials, Vol. 11, p. 141 (1999)). Further, a process for producing various electronic parts such as a high-density magnetic recording medium by using a PS-PMMA block copolymer or the like to form a pattern, selectively removing one component by etching and then transferring the pattern to a substrate is disclosed (Japanese Patent Application Laid-Open No. 2002-287377).

However, the above-described pattern forming processes disclosed to date using the micro phase separation structure of the block copolymer have involved a problem that heat resistance of the template is low because block chains making up the block copolymer are composed mainly of organic components.

### SUMMARY OF THE INVENTION

In order to solve the above problem, it is an object of the present invention to provide a photosensitive composition for forming a highly heat-resistant pattern of a micro phase separation structure.

According to the present invention, there is thus provided a photosensitive composition comprising:

(A) a block copolymer containing a segment composed of an alkoxysilyl-group-containing monomer as a repeating unit, and

(B) a photosensitive decomposition agent, wherein the polydispersity index (Mw/Mn) of the block copolymer is 1.8 or lower.

According to the present invention, there is also provided a process for producing a structured material containing a micro phase separation structure, which comprises the following steps of:

(1) a step of exposing a film formed of a composition comprising: (A) a block copolymer containing a segment composed of an alkoxysilyl-group-containing monomer as a repeating unit, whose polydispersity index (Mw/Mn) is 1.8 or lower, and (B) a photosensitive decomposition agent,

(2) a step of developing the film after the exposing step, and

(3) a step of heating the film after the developing step.

The composition comprising the block copolymer containing the segment composed of the repeating unit containing an inorganic component may form a pattern of a lower dimension than a photolithographic pattern in such a photolithographic pattern to form a structured material having a hierarchical structure with high heat resistance and solvent resistance that have heretofore not been achieved.

### DETAILED DESCRIPTION OF THE PREFERRED EMBODIMENTS

The first embodiment of the present invention is to provide a photosensitive composition comprising:

(A) a block copolymer containing a segment composed of an alkoxysilyl-group-containing monomer as a repeating unit, and

(B) a photosensitive decomposition agent, wherein the polydispersity index (Mw/Mn) of the block copolymer is 1.8 or lower.

Concerning the polydispersity index (Mw/Mn), ‘Mw’ and ‘Mn’ represent weight-average molecular weight and number-average molecular weight respectively.

The composition preferably further comprises: (C) a compound capable of crosslinking the block copolymer (A) in the presence of an acid or base.

The block copolymer (A) containing, as a component, the segment composed of the alkoxysilyl-group-containing monomer as the repeating unit will be first described. The block copolymer is a polymer in which homopolymer chains of monomers of at least two components are linked in one molecule. For example, a block copolymer formed by containing a segment A and a segment B is an AB type block copolymer of a two-component system. However, an ABC type, ABA type or BAB type triblock copolymer containing 3 components, or a multi-block copolymer containing still more components may also be used.

In the block copolymer used in the present invention, the alkoxysilyl-group-containing monomer is contained as a repeating unit in at least one block making up the block copolymer. The alkoxysilyl group is represented by the following general formula (1), and at least one alkoxysilyl group is contained in the monomer. 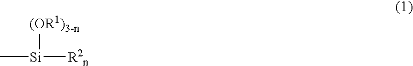
wherein R¹ and R² may be the same or different from each other and are, independently of each other, a monovalent organic group, and n is an integer of from 0 to 2.

As examples of the monovalent organic group in the formula (1), may be mentioned an alkyl group, alicyclic group, aryl group, allyl group and glycidyl group. Examples of the alkyl group include methyl, ethyl, propyl and butyl groups. The alkyl group preferably has 1 to 10 carbon atoms. These alkyl groups may be linear or branched, and the hydrogen atom may be substituted by a halogen atom such as fluorine atom. As examples of the alicyclic group, may be mentioned cyclohexyl and norbonyl groups. As examples of the aryl group, may be mentioned phenyl and naphthyl groups. Such a group that n in the formula (1) is 0 or 1 is preferably used. No particular limitation is imposed on the kind of the alkoxysilyl group so far as it is selected from the viewpoints of desired hydrolyzability, reaction rate, easy availability, cost and the like. No particular limitation is also imposed on the number of alkoxysilyl groups contained in one molecule of the monomer so far as at least one group is contained.

Specific examples of the alkoxysilyl-group-containing monomer include those represented by the following general formulae (2) to (4).

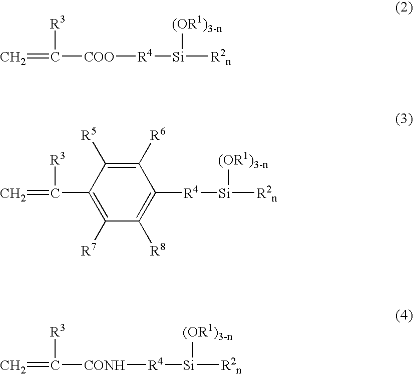

In the above formulae, R³ is hydrogen or a methyl group. R⁴ is an alkylene, alkylenearylenealkylene, arylene or alkylsilylene group or a single bond, and the alkylene group may contain —O—, —CO—, —COO—, —OCOO—, —S—, —SO₂— or —CONH—. R⁵ to R⁸ may be the same or different from one another and are, independently of one another, hydrogen, a (halogenated) alkyl group having 1 to 10 carbon atoms, such as a methyl, ethyl or trifluoromethyl group, a phenyl group, a p-fluorophenyl group, a naphthyl group, an aromatic-group-substituted alkyl group such as a benzyl group, a hydroxyalkyl group, an alkoxyalkyl group, a cyano group, a carboxyl group, an alkylcarbonyloxy group, an alkyloxycarbonyl group, or a substituent group selected from hydroxyl, amino, carbonyl, mercapto, aldehyde, amide and sulfonyl groups.

As the compounds represented by the formula (2), are used, for example, γ-(methacryloyloxypropyl)-trimethoxysilane, γ-(methacryloyloxypropyl)triethoxy-silane, γ-(methacryloyloxypropyl)tripropoxysilane, γ-(methacryloyloxypropyl)triisopropoxysilane, γ-(methacryloyloxypropyl)tributoxysilane, γ-(acryloyloxypropyl)triethoxysilane, γ-(acryloyloxypropyl)tripropoxy-silane, γ-(acryloyloxypropyl)triisopropoxysilane or γ-(acryloyloxypropyl)tributoxysilane. However, the compounds represented by the formula (2) are not particularly limited to these compounds.

As the compounds represented by the formula (3), are used, for example, vinylbenzyltrimethoxysilane, vinylbenzyltriethoxysilane, vinylbenzyltripropoxysilane, vinylbenzyltriisopropoxysilane, vinylbenzyltributoxy-silane and vinylbenzyltrimethoxydimethyldisilane. However, the compounds represented by the formula (3) are not particularly limited to these compounds.

As the compounds represented by the formula (4), are used, for example, (3-acrylamidopropyl)trimethoxy-silane, (3-acrylamidopropyl)triethoxysilane, (3-acrylamidopropyl)tripropoxysilane, (3-acrylamidopropyl)-triisopropoxysilane, (3-acrylamidopropyl)tributoxysilane and (3-methacrylamidopropyl)trimethoxysilane. However, the compounds represented by the formula (4) are not particularly limited to these compounds.

As other alkoxysilyl-group-containing unsaturated compounds, may be used, for example, vinyltrimethoxysilane, vinyltriethoxysilane, vinyltripropoxysilane, vinyltriisopropoxysilane and vinyltributoxysilane.

No particular limitation is imposed on the volume fraction of a block composed of the alkoxysilyl-group-containing monomer as a repeating unit contained in one molecule of the block copolymer in the present invention so far as it is such a fraction that a desired micro phase separation structure is formed. However, the volume fraction is desirably 5 to 95%. If the volume fraction is lower than 5% or higher than 95%, it may be difficult in some cases to form the micro phase separation structure.

The preparation process of the block copolymer containing, as a component, the segment composed of the alkoxysilyl-group-containing monomer as the repeating unit is based on a living polymerization process, and a living radical polymerization process is particularly preferably used. In the living radical polymerization process, various techniques have been developed in recent years, and the following examples are mentioned. For example, iniferter polymerization disclosed in Macromol. Chem. Rapid Commun., Vol. 3, p. 133 (1982), a process using a radical scavenger such as a nitroxide compound as disclosed in Macromolecules, Vol. 27, p. 7228 (1994), “Atom Transfer Radical Polymerization: ATRP” using an organic halide or the like as an initiator and a transition metal complex as a catalyst as disclosed in Journal of the American Chemical Society (J. Am. Chem. Soc.), Vol. 117, p. 5614 (1995), and “RAFT: Reversible Addition-Fragmentation Chain Transfer Polymerization” as disclosed in Macromolecules, Vol. 31, p. 5559 (1998) are mentioned. Among these, a synthetic process by the atom transfer radical polymerization process is particularly preferably used though the present invention is not particularly limited thereto.

As the initiator in this atom transfer radical polymerization process, may be suitably used organic halides, particularly, organic halides (for example, compounds having a halogen at an α-position and compounds having a halogen at a benzyl-position) having at least one carbon-halogen bond, which has high reactivity, in its molecule, sulfonyl halide compounds, and the like.

As specific examples thereof, may be mentioned 1-phenylethyl chloride, 1-phenylethyl bromide, chloromethylstyrene, chloroform, carbon tetrachloride, carbon tetrabromide, 2-chloropropionitrile, 2-bromopropionitrile, ethyl 2-chloroisopropionate, methyl 2-chloroisopropionate, methyl 2-bromisopropionate, ethyl 2-bromoisopropionate, methyl 2-bromoisobutyrate, ethyl 2-bromoisobutyrate, vinyl chloroacetate, p-toluenesulfonyl chloride, perfluoroethyl iodide, perfluoropropyl iodide, perfluorobutyl iodide, 2,2-bis(chloromethyl)-1,3-dichloropropane, 2,2-bis(bromomethyl)-1,3-dichloropropane, α,α′-dibromoxylene and hexakis(α-chloromethyl)benzene.

When the atom transfer radical polymerization process is used, a halogen-containing metal complex is used as a catalyst together with the above-described polymerization initiator to subject a radical-polymerizable monomer to living radical polymerization. As the metal catalyst, is used a catalyst composed of a metal complex, in which at least one transition metal (M) selected from metals belonging to Group 7 to Group 11 of the periodic table is a central metal. The metal (M) specifically used is a metal selected from the group consisting of Cu, Ni, Pd, Pt, Rh, Co, Ir, Fe, Ru, Re and Mn. Among these, Cu, Ru, Fe and Ni are preferred, with copper being particularly preferred. When copper is used as the central metal of the halogen-containing metal complex, cuprous chloride and cuprous bromide are particularly preferably used as the halogen-containing metal complexes. However, the metal complexes are not limited thereto.

An organic ligand is used in the metal complex. The organic ligand is used for solubilizing the metal complex in a polymerization solvent and permitting a reversible redox reaction of the metal complex. Examples of a coordinating atom to the metal include nitrogen, oxygen, phosphorus and sulfur atoms, and a nitrogen atom is preferred. Specific examples of the organic ligand include 2,2′-bipyridyl and derivatives thereof, tetramethylethylenediamine, pentamethyldiethylenetriamine, hexamethyltriethylenetetramine, tris(dimethylaminoethyl)-amine and triphenylphosphine. However, the organic ligands are not limited thereto.

Since the polymer obtained by the atom transfer radical polymerization process has a terminal halogen X capable of initiating additional polymerization, a first monomer may be consumed in polymerization to form a first block chain, and a second monomer may be then added to form a second block chain that starts to grow from the terminal of the first block chain. In other words, a block copolymer comprising a block chain composed of the alkoxysilyl-group-containing monomer as a repeating unit and a block chain composed of another monomer as a repeating unit can be prepared. In addition, a multi-block copolymer may also be prepared. With respect to the order of the block copolymerization, any of the alkoxysilyl-group-containing monomer and another monomer may be first polymerized. The block copolymer may also be a multi-block copolymer formed of 3 or more monomers.

In the present invention, as the monomer forming the block containing no alkoxysilyl group, may be used a publicly known radical-polymerizable monomer. Examples of the unsaturated monomers usable in the radical polymerization process according to the present invention are mentioned below. However, the monomers are not particularly limited thereto.

Examples of the unsaturated monomers include polymerizable unsaturated aromatic compounds such as styrene, α-, o-, m- or p-, alkyl-, alkoxy-, halogen-, haloalkyl-, nitro-, cyano-, amide- or ester-substituted products of styrene, styenesulfonic acid, 2,4-dimethylstyrene, p-dimethylaminostyrene, vinylbenzyl chloride, vinylbenzaldehyde, indene, 1-methylindene, acenaphthylene, vinylnaphthalene, vinylanthracene, vinyl-carbazole, 2-vinylpyridine, 4-vinylpyridine and 2-vinylfluorene; alkyl (meth)acrylates such as methyl (meth)acrylate, ethyl (meth)acrylate, n-propyl acrylate, n-butyl acrylate, 2-ethylhexyl (meth)acrylate and stearyl (meth)acrylate; esters of unsaturated monocarboxylic acids, such as methyl crotonate, ethyl crotonate, methyl cinnamate and ethyl cinnamate; fluoroalkyl (meth)acrylates such as trifluoroethyl (meth)acrylate, pentafluoropropyl (meth)acrylate and heptafluorobutyl (meth)acrylate; siloxanyl compounds such as trimethylsiloxanyldimethylsilylpropyl (meth)acrylate, tris(trimethylsiloxanyl)silylpropyl (meth)acrylate and di-(meth)acryloyl propyldimethylsilyl ether; hydroxyalkyl (meth)acrylates such as 2-hydroxyethyl (meth)acrylate, 2-hydroxypropyl (meth)acrylate and 3-hydroxypropyl (meth)acrylate; amine-containing (meth)acrylates such as dimethylaminoethyl (meth)acrylate, diethylaminoethyl (meth)acrylate and t-butylaminoethyl (meth)acrylate; hydroxyalkyl esters of unsaturated carboxylic acids, such as 2-hydroxyethyl crotonate, 2-hydroxypropyl crotonate and 2-hydroxypropyl cinnamate; unsaturated alcohols such as (meth)allyl alcohol; unsaturated (mono)carboxylic acids such as (meth)acrylic acid, crotonic acid and cinnamic acid; and epoxy group-containing (meth)acrylates such as glycidyl (meth)acrylate, glycidyl α-ethylacrylate, glycidyl α-n-propylacrylate, glycidyl α-n-butylacrylate, 3,4-epoxybutyl (meth)acrylate, 6,7-epoxyheptyl (meth)acrylate, 6,7-epoxyheptyl α-ethylacrylate, o-vinylbenzyl glycidyl ether, m-vinylbenzyl glycidyl ether, p-vinylbenzyl glycidyl ether, β-methylglycidyl (meth)acrylate, β-ethylglycidyl (meth)acrylate, β-propyl-glycidyl (meth)acrylate, β-methylglycidyl α-ethylacrylate, 3-methyl-3,4-epoxybutyl (meth)acrylate, 3-ethyl-3,4-epoxybutyl (meth)acrylate, 4-methyl-4,5-epoxypentyl (meth)acrylate and 5-methyl-5,6-epoxyhexyl (meth)acrylate, and mono- and diesters thereof; and besides, N-alkyl-substituted (meth)acrylamides such as N,N-dimethyl-acrylamide and N-isopropylacrylamide, N-methylol-acrylamide, N-methylolmethacrylamide, N-vinylpyrrolidone, unsaturated polycarboxylic acids and anhydrides thereof such as maleic acid, maleic anhydride, fumaric acid, itaconic acid, itaconic anhydride and citraconic acid, vinyl chloride, and vinyl acetate. The radical-polymerizable monomers exemplified above may be used either singly or in any combination thereof.

As the polymer making up the segment containing no alkoxysilyl group, polymers having an ester group or ether group in their main chains, particularly, aliphatic polyester type polymers or aliphatic polyether type polymers may be suitably used in addition to the polymers of the radical-polymerizable monomers. These polymers are useful for achieving the object of the present invention because the main chains of these polymers are generally lower in thermal decomposition temperature than a polymer composed of C—C bonds main chains obtained by the radical polymerization, and so a structured material can be formed even at a low annealing temperature, and because carbon (coke) residues after annealing is little. These polymers may be commercially available or synthesized as needed.

An ester unit making-up the aliphatic polyester in the present invention may be any structure so far as it is an ester unit containing no aromatic ring. However, it preferably contains any of ester structures represented by the following formulae (5) to (7). 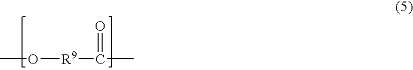
wherein R⁹ is a linear or branched alkylene group having 1 to 10 carbon atoms. 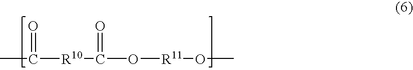
wherein R¹⁰ is a linear or branched alkylene group having 1 to 6 carbon atoms, and R¹¹ is a linear or branched alkylene group having 2 to 12 carbon atoms. 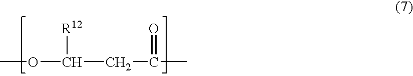
wherein R¹² is hydrogen or a linear or branched alkyl group having 1 to 12 carbon atoms.

R¹² in the formula (7) may be two or more different substituents (the polymer being a copolymer) selected from hydrogen and alkyl groups having 1 to 12 carbon atoms. When R¹² is a methyl group, the polymer is poly(3-hydroxybutyric acid). When R¹² is a methyl group and hydrogen, the polymer is a 3-hydroxybutyric acid/3-hydroxypropionic acid copolymer. When R¹² is a methyl group and an ethyl group, the polymer is a 3-hydroxybutyric acid/3-hydroxyvalerianic acid copolymer. The formulae (5) to (7) may be used either singly or in any combination thereof.

Polymers represented by these formulae (5) to (7) include hydroxy acid polycondensates, ring-opening polymers of lactones, polycondensates of an α,ω-aliphatic dicarboxylic acid and an α,ω-aliphatic diol, and the like. Specific examples thereof include hydroxy acid polycondensates such as polycondensates of hydroxybutyric acid; polyesters obtained by polycondensation of an α,ω-aliphatic dicarboxylic acid and an α,ω-aliphatic diol, such as polyethylene succinate, polybutylene succinate, polypentamethylene succinate, polyhexamethylene succinate, polyethylene adipate, polypentamethylene adipate and polyhexamethylene adipate, lactones such as poly(α-propiolactone), poly(β-propiolactone), poly(β-butyro-lactone), polypivalolactone, poly(α-valerolactone), poly(γ-valerolactone) and poly(ε-caprolactone), and lactides such as polylactides and polyglycolides. However, the polymers are not limited thereto.

An ether unit making up the aliphatic polyether in the present invention may be any structure so far as it is an ether unit containing no aromatic ring. However, a polymethylene oxide structure, a polyethylene oxide structure, a polypropylene oxide structure, a polytetramethylene oxide structure, a polybutylene oxide structure and the like are mentioned from the viewpoints of easy decomposability and easy availability. As specific examples thereof, may be mentioned ether type compounds such as polyoxymethylene alkyl ethers, polyoxyethylene alkyl ethers, polyoxyethylene-polyoxypropylene block copolymers and polyoxyethylene-polyoxypropylene alkyl ethers, ether ester type compounds such as polyoxyethylene glycerol fatty acid esters, polyoxyethylene sorbitan fatty acid esters and polyoxyethylene sorbitol fatty acid esters, and ether ester type compounds such as polyethylene glycol fatty acid esters, ethylene glycol fatty acid esters, fatty acid monoglycerides, polyglycerol fatty acid esters, sorbitan fatty acid esters and propylene glycol fatty acid esters. However, the compounds are not particularly limited thereto. Since the aliphatic polyester may be synthesized by using, as a starting point, the hydroxyl group present at both or one terminal of the aliphatic polyether polymer, the polymer making up the block containing no alkoxysilyl group in the present invention may also be a copolymer of the polyether type polymer and the polyester type polymer.

As the synthetic process of the block copolymer comprising the aliphatic polyester type or aliphatic polyether type polymer as the segment containing no alkoxysilyl group, may also be suitably used the living polymerization process. However, No particular limitation is imposed on the synthetic process. Even when the living polymerization process is used, (1) a polymer obtained by polymerizing an alkoxysilyl-group-containing monomer may be used directly as it is, or the functional group located at the polymer terminal may be transformed, to conduct block copolymerization with the aliphatic polyester or polyether, or (2) an aliphatic polyester or aliphatic polyether may be synthesized, and the polymer may be then used directly as it is, or the terminal functional group thereof may be transformed, to copolymerize the alkoxysilyl-group-containing monomer. The aliphatic polyester or aliphatic polyether used in the process (2) may be a commercially available compound.

The polymerization solvent used in the present invention may be any solvent so far as it has no inhibitory action on the radical polymerization. Among others, a solvent being compatible with the monomers used in the polymerization and having a structure that does not become an initiation species for the radical polymerization is advantageous from the viewpoint of the control of polymerization. Since a hydrolysis reaction of the alkoxysilyl group may progress during a polymerization reaction to fail to obtain a desired block copolymer when water is contained in the solvent, it is preferable to remove water in the solvent. Typical examples of specific polymerization solvents include alcohols such as methanol, ethanol, 1-propanol, 2-propanol, 1-butanol, 2-butanol, isobutyl alcohol, tert-butyl alcohol, 1-pentanol, 2-pentanol, 3-pentanol, 2-methyl-1-butanol, isopentyl alcohol, tert-pentyl alcohol, 1-hexanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic, alicyclic and aromatic hydrocarbons such as pentane, 2-methylbutane, n-hexane, cyclohexane, 2-methylpentane, 2,2-dimethyl-butane, 2,3-dimethylbutane, heptane, n-octane, isooctane, 2,2,3-trimethylpentane, decane, nonane, cyclopentane, methylcyclopentane, methylcyclohexane, ethylcyclohexane, p-menthane, dicyclohexyl, benzene, toluene, xylene, ethylbenzene and anisole (methoxybenzne); ethers such as ethyl ether, dimethyl ether, trioxane, tetrahydrofuran and diphenyl ether; acetals such as methylal and diethyl acetal; fatty acids such as formic acid, acetic acid and propionic acid; and sulfur- or nitrogen-containing organic compounds such as nitropropene, nitrobenzene, dimethylamine, monoethanolamine, pyridine, dimethylformamide, dimethyl sulfoxide and acetonitrile. These solvents may be used without particular limitations except for the above-described conditions of the solvents, and it is only necessary to suitably select a solvent fit for the polymerization process used. These solvents may be used either singly or in any combination thereof.

The atom transfer radical polymerization process in the present invention may be performed in various modes. For example, solution polymerization, suspension polymerization, emulsion polymerization and bulk polymerization may be mentioned. No particular limitation is imposed on the order of addition of polymerization reagents upon the practice of the present invention. However, the radical-polymerizable monomers, polymerization initiator, metal catalyst and its ligand used as needed are mixed, a proper solvent is additionally added as needed, degas and purging with an inert gas are conducted, and a reaction is then conducted with a polymerization temperature set to a prescribed temperature. The polymerization temperature is selected within a range of generally from 5 to 140° C., preferably from 20 to 120° C. If the polymerization temperature is lower than 5° C., the polymerization reaction becomes markedly slow. Thus, such a low temperature is not preferable from an industrial point of view. If the polymerization temperature exceeds 140° C. on the other hand, the resulting polymer shows a strong tendency for its molecular weight distribution to broaden. Thus, such a high temperature is not preferable.

The molecular weight distribution of the block copolymer containing, as a component, the segment composed of the alkoxysilyl-group-containing monomer as the repeating unit is preferably as narrow as possible. The polydispersity index (Mw/Mn) that gives an index to the molecular weight distribution is identified by gel permeation chromatography (GPC). The polydispersity index (Mw/Mn) of the block copolymer according to the present invention is preferably 1.8 or lower, more preferably 1.5 or lower. If the polydispersity index is great, such a block copolymer shows a tendency to disorder the periodicity and size of its micro phase separation structure. If the polydispersity index (Mw/Mn) is 5 or higher, the block copolymer is nonuniform, so that photosensitive compositions that bring forth uniform effect cannot be provided.

The photosensitive decomposition agent (B) will now be described. The photosensitive decomposition agent (B) used in the present invention may be a photosensitive acid generator or photosensitive base generator.

As the photosensitive acid generator, a publicly known compound may be optionally selected for use so far as it is a compound capable of generating an acid by exposure to actinic rays. As examples thereof, may be mentioned onium salts such as diazonium salts, iodonium salts, bromonium salts, chloronium salts, sulfonium salts, selenonium salts and pyridinium salts, halogen compounds such as halogen-containing triazines, and sulfonyl imide compounds. However, iodonium salts such as diphenyliodonium trifluoromethylsulfonates, sulfonium salts such as triphenylsulfonium hexafluoroantimonate, halogen-containing triazines, and sulfonic esters may preferably be used.

As the iodonium salts, may be used, for example, diphenyliodonium tetrafluoroborate, diphenyliodonium hexafluorophosphonate, diphenyliodonium hexafluoro-arsenate, diphenyliodonium trifluoromethanesulfonate, diphenyliodonium trifluoroacetate, diphenyliodonium p-toluenesulfonate, diphenyliodonium butyltris(2,6-difluorophenyl)borate, diphenyliodonium hexyltris(p-chlorophenyl)borate, 4-methoxyphenylphenyliodonium tetrafluoroborate, 4-methoxyphenylphenyliodonium hexafluorophosphonate, 4-methoxyphenylphenyliodonium hexafluoroarsenate, 4-methoxyphenylphenyliodonium trifluoromethanesulfonate, 4-methoxyphenylphenyliodonium trifluoroacetate and 4-methoxyphenylphenyliodonium p-toluenesulfonate.

As the sulfonium salts, may be used, for example, triphenylsulfonium tetrafluoroborate, triphenylsulfonium hexafluorophosphonate, triphenylsulfonium hexafluoroarsenate, triphenylsulfonium trifluoromethane-sulfonate, triphenylsulfonium trifluoroacetate, triphenylsulfonium p-toluenesulfonate, 4-methoxyphenyl-diphenylsulfonium tetrafluoroborate, 4-methoxyphenyl-diphenylsulfonium p-toluenesulfonate, 4-phenylthiophenyl-diphenylsulfonium hexafluorophosphonate, 4-phenyl-thiophenyldiphenylsulfonium hexafluoroarsenate and 4-phenylthiophenyldiphenylsulfonium trifluoromethane-sulfonate.

As the halogen-containing triazines, may be used, for example, tris(2,4,6-trichloromethyl)-s-triazine, 2-phenyl-4,6-bis(trichloromethyl)-s-triazine, 2-(4-chlorophenyl)-4,6-bis(trichloromethyl)-s-triazine, 2-(3-chlorophenyl)-4,6-bis(trichloromethyl)-s-triazine, 2-(2-chlorophenyl)-4,6-bis(trichloromethyl)-s-triazine, 2-(4-methoxyphenyl)-4,6-bis(trichloromethyl)-s-triazine and tris(trichloromethyl)-s-triazine.

As the sulfonic esters, may be used, for example, α-hydroxymethylbenzoin p-toluenesulfonate, α-hydroxy-methylbenzoin trifluoromethanesulfonate, α-hydroxy-methylbenzoin methanesulfonate, 2,4-dinitrobenzyl p-toluenesulfonate, 2,4-dinitrobenzyl trifluoromethane-sulfonate, 2,4-dinitrobenzyl methanesulfonate, 2,4-dinitrobenzyl 1,2-naphthoquinonediazido-5-sulfonate, 2,6-dinitrobenzyl p-toluenesulfonate, 2-nitrobenzyl p-toluene-sulfonate, 2-nitrobenzyl trifluoromethanesulfonate, 2-nitrobenzyl methanesulfonate, 4-nitrobenzyl p-toluene-sulfonate, 4-nitrobenzyl trifluoromethanesulfonate, 4-nitrobenzyl methanesulfonate and 4-nitrobenzyl 1,2-naphthoquinonediazido-5-sulfonate.

As the photosensitive base generator, may be suitably used, for example, those described in Japanese Patent Application Laid-Open No. H04-330444, “Polymers”, Vol. 46, No. 6, pp. 242-248 (1997) and the like. Specific examples thereof include triphenylmethanol and benzyl carbamate. However, the base generators are not limited thereto so far as a base is generated by exposure to actinic rays.

The photosensitive acid generators or photosensitive base generators may be used either singly or in any combination thereof. The above-described photosensitive decomposition agent (B) is preferably used in a proportion of 0.01 part by mass or more, more preferably 0.05 part by mass or more per 100 parts by mass of the block copolymer (A). If the proportion of the component (B) is lower than 0.01 parts by mass, the resulting composition tends to lower its sensitivity to irradiation rays. The upper limit value of the proportion is preferably 20 parts by mass or less, more preferably 15 parts by mass or less. If the proportion of the component (B) exceeds 20 parts by mass, the resultant coating film tends to leave residues upon development.

The compound (C) capable of crosslinking the alkoxysilyl-group-containing block copolymer in the presence of an acid or base, which is used in the present invention, will now be described. As the compound capable of crosslinking the alkoxysilyl-group-containing block copolymer, may be used at least one compound selected from the group consisting of metal alkoxides represented by the following formula (5) and metal halides represented by the following formula (6)
M(OR)ₜYᵤ (5)
MXₜYᵤ (6)
wherein M is a divalent to pentavalent atom, R is an alkyl or aryl group, Y is hydrogen, or an alkyl, aryl, hydroxyl, alkoxy or aryloxy group, X is halogen, and t and u are each 0 or an integer of 1 or greater, with the proviso that t+u is equal to the valence number of the atom M.

As the divalent to pentavalent atom M in the formulae (5) and (6), may be used, for example, Si, P or a metal atom. As the metal atom, is preferred, for example, an atom belonging to Group 2A or 3B of the periodic table or an atom of transition metals.

In the above formulae, all the alkyl groups or alkyl groups in the alkoxy groups may be linear, branched or cyclic alkyl groups having 1 to 10 carbon atoms. A part or the whole of the hydrogen atoms contained in these alkyl groups may be substituted by chlorine or bromine, or a perfluoroalkyl, hydroxyl, mercapto, thioalkyl, alkoxy, alkyl ester, alkyl thioester, perfluoroalkyl ester, cyano, nitro or aryl group.

In the above formulae, all the aryl groups or aryl groups in the aryloxy groups may be, independent of each other, for example, a phenyl, naphthyl, anthracenyl or biphenyl group, and the hydrogen atoms thereof may be substituted by chlorine or bromine, or a hydroxyl, mercapto, alkoxy, thioalkyl, alkyl ester, alkyl thioester, cyano or nitro group.

As preferable examples of halogen, may be mentioned fluorine, chlorine and bromine.

Examples of compounds represented by the formula (5) and usable in the present invention include, as silicon compounds, tetraalkoxysilanes such as tetramethoxysilane, tetraethoxysilane (common name, TEOS), tetra-n-propyloxysilane, tetraisopropyloxysilane and tetra-n-butoxysilane; monoalkyltrialkoxysilanes such as methyltrimethoxysilane, methyltriethoxysilane, ethyltriethoxysilane and cyclohexyltriethoxysilane; monoaryltrialkoxysilanes such as phenyltriethoxysilane, naphthyltriethoxysilane, 4-chlorophenyltriethoxysilane and 4-methylphenyltriethoxysilane; monoaryloxytrialkoxy-silanes such as phenoxytriethoxysilane, naphthyloxy-triethoxysilane, 4-chlorophenyloxytriethoxysilane and 4-methylphenyloxytriethoxysilane; monohydroxytrialkoxy-silanes such as monohydroxytrimethoxysilane and monohydroxytriethoxysilane; dialkyldialkoxysilanes such as dimethyldimethoxysilane and dimethyldiethoxysilane; monoalkylmonoaryldialkoxysilanes such as methyl(phenyl)-diethoxysilane; monoalkylmonohydroxydialkoxysilanes such as methyl(hydroxy)dimethoxysilane; trialkylmonoalkoxy-silanes such as trimethylmethoxysilane and trimethylethoxysilane; and oligomers of the above-mentioned compounds, such as a dimer to pentamer of tetramethoxysilane.

Specific examples of compounds represented by the formula (6) and usable in the present invention include, as silicon compounds, tetrahalogenosilanes such as tetrachlorosilane, tetrabromosilane, tetraiodosilane, trichlorobromosilane and dichlorodibromesilane; monoalkyltrihalogenosilanes such as methyltrichlorosilane, methyldichlorobromosilane and cyclohexyltrichlorosilane; monoaryltrihalogenosilanes such as phenyltrichlorosilane, naphthyltrichlorosilane and 4-chlorophenyltrichloro-silane; monoaryloxytrihalogenosilanes such as phenoxy-trichlorosilane and phenoxydichlorobromosilane; monoalkoxytrihalogenosilanes such as methoxytrichloro-silane and ethoxytrichlorosilane; dialkyldihalogeno-silanes such as dimethyldichlorosilane, methyl (ethyl)-dichlorosilane and methyl(cyclohexyl)dichlorosilane; monoalkylmonoaryldihalogenosilanes such as methyl(phenyl)dichlorosilane; and oligomers of the above-mentioned compounds, such as a dimer to pentamer of tetrachlorosilane.

As other compounds represented by the formula (5) or (6), may be likewise used, for example, triethoxyboron, boron trichloride, diethoxymagnesium, magnesium dichloride, triethoxyaluminum, tributoxyaluminum, aluminum trichloride, triethoxyphosphorus, phosphorus trichloride, pentaethoxyphosphorus, phosphorus pentachloride, tetraethoxytitanium, tetraisopropoxy-titanium, tetrabutoxytitanium, titanium tetrachloride, diethoxyiron, iron dichloride, triethoxyiron, iron trichloride, diethoxynickel, nickel dichloride, triethoxygallium, gallium trichloride, tetramethoxy-germanium, tetraethoxygermanium, germanium tetrachloride, diethoxystrontium, strontium dichloride, triethoxyyttrium, yttrium trichloride, tetramethoxyzirconium, tetraethoxy-zirconium, tetrabutoxyzirconium, zirconium tetrachloride, diethoxycadmium, cadmium dichloride, triethoxyindium, indium trichloride, diethoxybarium, barium dichloride, hexaethoxytungsten, tungsten hexachloride, pentaethoxy-tantalum, tantalum pentachloride, diethoxylead, lead dichloride, triethoxybismuth and bismuth trichloride in addition to the above-mentioned compounds.

Among these, tetraalkoxysilanes such as tetramethoxysilane and tetraethoxysilane; trialkoxy-aluminum compounds such as tributoxyaluminum; tetraalkoxytitanium compounds such as tetrabutoxy-titanium; tetraalkoxyzirconium compounds such as tetrabutoxyzirconium; tetrahalogenosilanes such as tetrachlorosilane; trihalogenoaluminum compounds such as aluminum trichloride; and tetrahalogenotitanium compounds such as titanium tetrachloride are preferably used.

As the component (C), the above-mentioned compounds may be used either singly or in any combination thereof. The content of the compound of the component (C) in the composition may be freely set according to mechanical properties, and exposure properties and development properties in a photolithographic process. However, it is preferably used in a proportion of 100 parts by mass or less, more preferably 60 parts by mass or less per 100 parts by mass of the block copolymer (A). When the content of the component (C) exceeds 100 parts by mass per 100 parts by mass of the component (A), the crosslinking degree of the resulting composition becomes too high, so that it may be difficult in some cases to form a micro phase separation structure. The lower limit value of the component (C) may be freely set according to the properties of the intended nano-structured material and processes. However, it is 0.1 parts by mass or more per 100 parts by mass of the component (A). When a composition comprising the component (C) is prepared, the photosensitive decomposition agent (B) is preferably used in a proportion of 0.01 parts by mass or more, more preferably 0.05 parts by mass or more per 100 parts by mass of the block copolymer (A). If the proportion of the component (B) is lower than 0.01 parts by mass, the resulting composition tends to lower its sensitivity to irradiation rays. The upper limit value of the proportion of the component (B) is preferably 20 parts by mass or less, more preferably 15 parts by mass or less. If the proportion of the component (B) exceeds 20 parts by mass, the resultant coating film tends to leave residues upon development.

Other additives may be contained in the photosensitive composition used in the present invention within limits not impairing the object of the present invention. Such additives include silane coupling agents, sensitizers, ultraviolet absorbents, surfactants and the like.

Examples of the silane coupling agents used include 3-glycidyloxypropyltrimethoxysilane, 3-aminoglycidyloxy-propyltriethoxysilane, 3-methacryloxypropyltrimethoxy-silane, 3-glycidyloxypropylmethyldimethoxysilane, 1-methacryloxypropylmethyldimethoxysilane, 3-aminopropyl-trimethoxysilane, 3-aminopropyltriethoxysilane, 2-amino-propyltrimethoxysilane, 2-aminopropyltriethoxysilane, N-(2-aminoethyl)-3-aminopropyltrimethoxysilane, N-(2-amino-ethyl)-3-aminopropylmethyldimethoxysilane, 3-ureido-propyltrimethoxysilane, 3-ureidopropyltriethoxysilane, N-trimethoxysilylpropyltriethylenetriamine, N-triethoxy-silylpropyltriethylenetriamine, 10-trimethoxysilyl-1,4,7-triazadecane, 10-triethoxysilyl-1,4,7-triazadecane, N-benzyl-3-aminopropyltrimethoxysilane, N-benzyl-3-amino-propyltriethoxysilane, N-phenyl-3-aminopropyltrimethoxy-silane and N-phenyl-3-aminopropyltriethoxysilane. These agents may be used either singly or simultaneously in combination of 2 or more thereof.

Specific examples of the sensitizers used include benzoin, benzoin methyl ether, benzoin ethyl ether, 9-fluorenone, 2-chloro-9-fluorenone, 2-methyl-9-fluorenone, 9-anthrone, 2-bromo-9-anthrone, 2-ethyl-9-anthrone, 9,10-anthraquinone, 2-ethyl-9,10-anthraquinone, 2-t-butyl-9,10-anthraquinone, 2,6-dichloro-9,10-anthraquinone, xanthone, 2-methylxanthone, 2-methoxyxanthone, thioxanthone, benzyl, dibenzalacetone, p-(dimethylamino)-phenyl styryl ketone, p-(dimethylamino)phenyl p-methyl-styryl ketone, benzophenone, p-(dimethylamino)-benzophenone, N-phenyl-1-naphthylamine, N,N-diphenyl-1-naphthylamine, aminopyrene, N-phenylaminopyrene, N,N-diphenylaminopyrene, N-chlorophenylaminopyrene, N,N-dichlorophenylaminopyrene, triphenylamine, p-hydroxy-triphenylamine, N-phenyl-N-benzyl-1-naphthylamine and N-phenyl-N-styryl-1-naphthylamine.

A process for forming a nano-structured material composed of an inorganic component alone using the photosensitive composition will now be described. The photosensitive composition according to the present invention is prepared as a composition solution upon its use by dissolving it in a solvent so as to give a solid content concentration of, for example, 0.1 to 50% by mass, and filtering the resultant solution through a filter having a pore size of, for example, about 0.1 to 10 μm.

As examples of the solvent, may be mentioned glycol ethers such as ethylene glycol monomethyl ether and ethylene glycol monoethyl ether; ethylene glycol alkyl ether acetates such as methyl cellosolve acetate and ethyl cellosolve acetate; diethylene glycols such as diethylene glycol monomethyl ether, diethylene glycol monoethyl ether, diethylene glycol dimethyl ether and diethylene glycol ethyl methyl ether; propylene glycol monoalkyl ethers such as propylene glycol methyl ether, propylene glycol ethyl ether, propylene glycol propyl ether and propylene glycol butyl ether; propylene glycol alkyl ether acetates such as propylene glycol methyl ether acetate, propylene glycol ethyl ether acetate, propylene glycol propyl ether acetate and propylene glycol butyl ether acetate; propylene glycol alkyl ether propionates such as propylene glycol methyl ether propionate, propylene glycol ethyl ether propionate, propylene glycol propyl ether propionate and propylene glycol butyl ether propionate; aromatic hydrocarbons such as toluene and xylene; ketones such as methyl ethyl ketone, cyclohexanone and 4-hydroxy-4-methyl-2-pentanone; and esters such as methyl acetate, ethyl acetate, propyl acetate, butyl acetate, ethyl 2-hydroxypropionate, methyl 2-hydroxy-2-methylpropionate, ethyl 2-hydroxy-2-methyl-propionate, methyl hydroxyacetate, ethyl hydroxyacetate, butyl hydroxyacetate, methyl lactate, ethyl lactate, propyl lactate and butyl lactate. These solvents may be used either singly or in any combination thereof.

In order to control the solubility to these solvents and vapor pressure, an alcohol such as methyl alcohol, ethyl alcohol, n-propyl alcohol or isopropyl alcohol, an aliphatic hydrocarbon such as pentane, hexane, heptane or octane, an alicyclic compound such as cyclopentanone or cyclohexane, or the like may be mixed with the solvents.

In the present invention, the photosensitive composition is used, whereby an inorganic nano-structured material based on a micro phase separation structure can be formed in a photolithographic pattern in, for example, the following manner. This process will be described.

A coating film is first-formed on the surface of a substrate such as a silicon wafer with the photosensitive composition solution filtered. At this time, a coating means such as a spin coating, dipping, roll coating or spraying method may be used as a coating method.

The resultant coating film is subjected to an exposure step (a) through, for example, a patterned mask to generate an acid or base from the component (B) in a part of the coating film. This acid or base acts on the alkoxysilyl group in the block copolymer of the component (A) and also on the component (C) if the component (C) has been added to form —SiOH or -M-OH (“M” represents a metal atom in the component (C)). A crosslinking reaction is subsequently allowed to progress by a heating step (b). A development step (c) is then conducted, whereby the exposed portion is insolubilized by the crosslinking, while the non-exposed portion is dissolved in a developer to form a pattern. A micro phase separation structure is then formed by a step (d) of reheating at a proper temperature higher than the glass transition temperature (Tg) of the block copolymer, and at the same time, the crosslinking reaction is allowed to further progress to complete the formation of the pattern by the photolithographic process. Finally, after the micro phase separation structure is formed, an organic polymer phase is selectively removed by a step (e) of heating to at least a temperature at which the organic substance is decomposed, whereby a nano-structured material composed of inorganic substance alone using the micro phase separation structure of the block copolymer as a template is formed in the pattern by the photolithographic process. As the method for removing the organic substance in this process, the organic substance may be removed by reactive ion etching (RIE) utilizing a great etching contrast between the organic substance and the inorganic substance in place of the removal of the organic substance by thermal decomposition in the annealing step (e). As an etching gas used in this case, O₂ gas is preferably used.

In the pattern-forming process in the present invention, a heat treatment (hereinafter referred to as “soft bake”) is preferably conducted for removing the solvent in the coating film after the coating by the spin coating or the like. Heating conditions thereof vary according to the blending composition of the materials according to the present invention, the kinds of various additives, and the like. However, the heating may be conducted at preferably 30 to 200° C., more preferably 40 to 150° C. by means of a hot plate, an oven, infrared rays or the like. The respective steps in the pattern formation of the nano-structured material composed of the inorganic substance will hereinafter be described in more detail.

In the exposure step (a), the acid or base generated by the exposure to light acts on the alkoxysilyl group in the block copolymer of the component (A) and the component (C) if the component (C) has been added to form —SiOH or -M-OH (“M” represents a metal atom in the component (C)). Examples of the irradiation light in the exposure step include i line at a wavelength of 365 nm, h line at 404 nm, g line at 436 nm, ultraviolet rays from wide-wavelength light sources such as a xenon lamp, or the like, far ultraviolet rays such as KrF excimer laser beams at a wavelength of 248 nm and ArF excimer laser beams at a wavelength of 193 nm, visible rays, and mixed rays thereof. Among these, the ultraviolet rays and visible rays are preferred. The irradiance varies according to the irradiation wavelength and the like. However, it is preferably controlled to 0.1 mW/cm² to 100 MW/cm² because the reaction efficiency becomes best. The coating film is irradiated with these irradiation rays through a patterned mask, whereby the coating film can be patterned.

It is preferable to conduct a heat treatment (post-exposure bake (PEB)) step (b) after the exposure. By this step, a condensation reaction is caused between the —SiOH or -M-OH groups formed by the exposure to facilitate the crosslinking reaction in the block copolymer. The same device as in the above-described soft bake may be used in the heating, and conditions thereof may be optionally set. The heating temperature is preferably 30 to 150° C., more preferably 40 to 130° C. If the heating temperature is lower than 30° C., the degree of progress of the crosslinking reaction becomes too low. If the heating temperature is higher than 150° C., the crosslinking reaction excessively progresses to disorder the micro phase separation structure or inhibit the formation itself of the micro phase separation structure.

No particular limitation is imposed on the developer in the development step (c) according to the present invention so far as it can dissolve the block copolymer of the component (A), the photosensitive decomposition agent of the component (B) and the crosslinking agent of the component (C) in the composition. Specific examples of usable developers include alcohols such as isopropyl alcohol (IPA), aromatic hydrocarbons such as toluene and xylene, and ketones such as methyl ethyl ketone (MEK) and methyl isobutyl ketone (MIBK). A surfactant or the like may also be added to the developer.

By the reheating step (d) after the development, the micro phase separation structure is completely formed, and the crosslinking reaction in the block copolymer is also completed. The same device as in the above-described soft bake may be used in the heating, and conditions thereof may be optionally set. It is only necessary to determine the heating temperature according to the structure of the block copolymer used. More specifically, a temperature, at which the block copolymer is not decomposed, and which is higher than the glass transition temperature (Tg) of the block chain making up the block copolymer, is preferred, and it is generally 50 to 250° C., more preferably 80 to 200° C.

The annealing step (e) for removing the organic substance is preferably conducted at the decomposition temperature of the organic polymer or higher. The temperature is generally 300° C. or higher, preferably 450° C. or higher. It is however only necessary to suitably set the temperature according to the structure of the block copolymer.

In the photolithographic process of the present invention, the whole surface of the coating film may be directly exposed through no mask, and the reheating step (d) and the annealing step (e) may be conducted without conducting the development step (c).

In the present invention, in some cases, the micro phase separation structure may be formed at a high temperature according to the structure of the block copolymer used to inhibit the formation of the micro phase separation structure because the crosslinking reaction excessively progresses if the steps are performed in the above-described order. In such a case, the pattern-forming process may also be performed by a process comprising forming a pattern in order of: (d) the heating step at temperature higher than Tg, (a) the exposure step, (b) the PEB step, (c) the development step and (e) the annealing step, to form a micro phase separation structure, and then allowing the crosslinking reaction to progress. The above-described order of the steps may be suitably set according to the structure of the block copolymer used.

A porous film of the inorganic substance exhibits a low dielectric constant compared with low-dielectric constant interlayer dielectric films (dielectric constant: generally 2.5 to 3.5) which have been conventionally used and can be used in electronic parts such as semiconductor devices and multi-layer wiring boards. More specifically, it is useful for applications to an interlayer dielectric film for semiconductor elements such as LSI and DRAM, an etching stopper film, an intermediate layer in a semiconductor fabrication process using a multi-layer resist, an interlayer dielectric film for multi-layer wiring boards, and a overcoat film and an insulation film for liquid crystal display devices.

The present invention will hereinafter be described in more detail by the following examples. However, the present invention is not limited to the following examples.

### SYNTHESIS EXAMPLE 1

Poly(methyl methacrylate)-b-poly(trimethoxysilyl-propyl methacrylate) (PMMA-b-PTMSPMA; “b” is a symbol indicating a block copolymer) was synthesized in accordance with the following procedure using the atom transfer radical polymerization process. Under a nitrogen atmosphere, 0.5 mmol of copper bromide, 1.0 mmol of 2,2′-dinonylbipyridyl, 1.0 mmol of p-toluenesulfonyl chloride, 150 mmol of methyl methacrylate and 15 g of diphenyl ether were mixed, dissolved oxygen was purged with nitrogen, and the reaction was then conducted at 80° C. The reaction was conducted while monitoring the monomer conversion by gas chromatography, and the resultant reaction mixture was quenched with liquid nitrogen to terminate the reaction. The molecular weight of the thus-obtained PMMA was identified by GPC. As a result, its number average molecular weight (Mn) was 8,300, and its polydispersity index (Mw/Mn) was 1.07. Then, 0.4 mmol of the resultant poly(methyl methacrylate) having chlorine at its terminal, 0.2 mmol of copper(I) bromide, 0.2 mmol of pentamethyldiethylenetriamine, 160 mmol of TMSPMA and 30 ml of anisole were mixed, and the resultant mixture was purged with nitrogen. After the reaction was conducted at 80° C., the resultant reaction mixture was quenched with liquid nitrogen to terminate the reaction. After purification by reprecipitation in methanol, the molecular weight of the thus-obtained PMMA-b-PTMSPMA was identified by GPC. As a result, its Mn was 55,300, and its Mw/Mn was 1.25. From this result, the molecular weights of the respective blocks were calculated to be 8,300 for the PMMA block and 47,000 for the PTMSPMA block. This result well coincides with the compositional ratio between both blocks determined from the peak integrated value ratio of ¹H-NMR.

### SYNTHESIS EXAMPLE 2

PMMA-b-PTMSPMA having a composition different from the block copolymer in SYNTHESIS EXAMPLE 1 was synthesized in accordance with the following procedure using the atom transfer radical polymerization process. Under a nitrogen atmosphere, 0.2 mmol of copper bromide, 0.4 mmol of 2,2′-dinonylbipyridyl, 0.4 mmol of p-toluenesulfonyl chloride, 136 mmol of methyl methacrylate and 13 g of diphenyl ether were mixed, dissolved oxygen was purged with nitrogen, and the reaction was then conducted at 80° C. The reaction was conducted while monitoring monomer conversion by gas chromatography, and the resultant reaction mixture was quenched with liquid nitrogen to terminate the reaction. The molecular weight of the thus-obtained PMMA was identified by GPC. As a result, its Mn was 21,200, and its Mw/Mn was 1.11. Then, 0.4 mmol of the resultant poly(methyl methacrylate) having chlorine at its terminal, 0.2 mmol of copper(I) bromide, 0.2 mmol of pentamethyldiethylene-triamine, 160 mmol of TMSPMA and 30 ml of anisole were mixed, and the resultant mixture was purged with nitrogen. After the reaction was conducted at 80° C., the resultant reaction mixture was quenched with liquid nitrogen to terminate the reaction. After purification by reprecipitation in methanol, the molecular weight of the thus-obtained PMMA-b-PTMSPMA was identified by GPC. As a result, its. Mn was 71,900, and its Mw/Mn was 1.28. From this result, the molecular weights of the respective blocks were calculated to be 21,200 for the PMMA block and 50,700 for the PTMSPMA block. This result well coincides with a compositional ratio between both blocks determined from the peak integrated value ratio of ¹H-NMR.

### SYNTHESIS EXAMPLE 3

Poly(ethylene glycol methyl ether)-b-poly(trimethoxysilylpropyl methacrylate) (PEG-b-PTMSPMA) was synthesized in accordance with the following procedure using the atom transfer radical polymerization process. Poly(ethylene glycol methacrylate) (Mn: 10,000) dissolved in tetrahydrofuran (THF) was reacted with 2-bromoisobutyryl bromide at 0° C. in the presence of triethylamine to obtain poly(ethylene glycol methylether-ethyl-2-bromoisobutyrate) (PEG-Br). Then, 0.5 mmol of the resultant PEG-Br, 0.25 mmol of copper(I) bromide, 0.25 mmol of pentamethyldiethylenetriamine, 100 mmol of TMSPMA and 25 ml of anisole were mixed, and the resultant mixture was purged with nitrogen. After the reaction was conducted at 80° C., the resultant reaction mixture was quenched with liquid nitrogen to terminate the reaction. After purification by reprecipitation in methanol, the molecular weight of the thus-obtained PEG-b-PTMSPMA was identified by GPC. As a result, its Mn was 32,100, and its Mw/Mn was 1.35. From this result, the molecular weights of the respective blocks were calculated to be 10,000 for the PEG block and 22,100 for the PTMSPMA block. This result well coincides with a compositional ratio between both blocks determined from the peak integrated value ratio of ¹H-NMR.

### SYNTHESIS EXAMPLE 4

Poly(styrene)-b-poly(vinylbenzyltrimethoxysilane) (PSt-b-PVBTMS) was synthesized in accordance with the following procedure using the atom transfer radical polymerization process. Vinylbenzyltrimethoxysilane (VBTMS) was synthesized by using a Grignard reagent in accordance with the process described in “KOBUNSHI RONBUNSHU”, Vol. 38, p. 201 (1981). Under a nitrogen atmosphere, 1.7 mmol of copper(I) bromide, 1.7 mmol of pentamethyldiethylenetriamine, 1.7 mmol of 1-phenylethyl bromide and 425 mmol of St were mixed, dissolved oxygen was purged with nitrogen, and St was then bulk-polymerized at 110° C. The reaction was conducted while monitoring the monomer conversion by gas chromatography, and the resultant reaction mixture was quenched with liquid nitrogen to terminate the reaction. The molecular weight of the thus-obtained polystyrene was identified by GPC. As a result, its Mn was 16,600, and its Mw/Mn was 1.17. Then, 0.4 mmol of the resultant polystyrene having chlorine at its terminal, 0.2 mmol of copper(I) bromide, 0.2 mmol of pentamethyldiethylene-triamine, 150 mmol of VBTMS and 30 ml of anisole were mixed, and the resultant mixture was purged with nitrogen. After the reaction was conducted at 100° C., the resultant reaction mixture was quenched with liquid nitrogen to stop the reaction. After purification by reprecipitation in methanol, the molecular weight of the thus-obtained PSt-b-PVBTMS was identified by GPC. As a result, its Mn was 55,800, and its Mw/Mn was 1.31. From this result, the molecular weights of the respective blocks were calculated to be 16,600 for the PSt block and 39,200 for the PVBTMS block. This result well coincides with the compositional ratio between both blocks determined from a peak integrated value ratio of ¹H-NMR.

### SYNTHESIS EXAMPLE 5

Poly(ethylene glycol methyl ether)-b-poly(trimethoxysilylpropyl methacrylate) (PEG-b-PTMSPMA) was synthesized in accordance with the following procedure using the atom transfer radical polymerization process. Poly(ethylene glycol methacrylate) (Mn: 10,000) dissolved in tetrahydrofuran (THF) was reacted with 2-bromoisobutyryl bromide at 0° C. in the presence of triethylamine to obtain poly(ethyleneglycol methylether-ethyl-2-bromoisobutyrate) (PEG-Br). Then, 0.5 mmol of the resultant PEG-Br, 0.25 mmol of copper(I) bromide, 0.25 mmol of pentamethyldiethylenetriamine, 100 mmol of TMSPMA and 25 ml of anisole were mixed, and the resultant mixture was purged with nitrogen. After the reaction was conducted at 80° C., the resultant reaction mixture was quenched with liquid nitrogen to terminate the reaction. After purification by reprecipitation in methanol, the molecular weight of the thus-obtained PEG-b-PTMSPMA was identified by GPC. As a result, its Mn was 32,100, and its Mw/Mn was 1.35. From this result, the molecular weights of the respective blocks were calculated to be 10,000 for the PEG block and 22,100 for the PTMSPMA block. This result well coincides with the compositional ratio between both blocks determined from a peak integrated value ratio of ¹H-NMR.

### SYNTHESIS EXAMPLE 6

Poly(lactide)-b-poly(vinylbenzyltrimethoxysilane) (PLA-b-PVBTMS) was synthesized in accordance with the following procedure using a polymerization process by a nitroxide compound. Vinylbenzyltrimethoxysilane (VBTMS) was synthesized in the same manner as in SYNTHESIS EXAMPLE 4. After 0.2 mmol of 4-hydroxy TEMPO was dissolved in dry toluene, 40 mmol of lactide (3,6-dimethyl-1,4-dioxane-2,5-dione) and tin 2-ethylhexanoate (catalyst, 45 mg) dissolved in 5 ml of dry toluene were added to the solution followed by mixing. After the resultant mixture was well stirred, and toluene was evaporated, degas was conducted repeatedly several times to completely remove water, and the interior of a reaction vessel was evacuated. The lactide was then polymerized at 110° C. to obtain a polylactide having TEMPO at its terminal. The molecular weight of the thus-obtained polylactide having TEMPO at its terminal was identified by GPC. As a result, its Mn was 9,100, and its Mw/Mn was 1.11. After 0.2 mmol of the resultant polylactide having TEMPO at its terminal, 0.2 mmol of pentamethyldiethylene-triamine, 150 mmol of VBTMS and 0.18 mmol of benzoyl peroxide were mixed, and degas was conducted repeatedly several times to remove water and oxygen, the system was purged with nitrogen. After the reaction was conducted for 3.5 hours at 95° C., and subsequently polymerization was conducted for 60 hours at 125° C., the resultant reaction mixture was quenched with liquid nitrogen to terminate the reaction. After purification by reprecipitation in methanol, the molecular weight of the thus-obtained PLA-b-PVBTMS was identified by GPC. As a result, its Mn was 49,500, and its Mw/Mn was 1.41. From this result, the molecular weights of the respective blocks were calculated to be 9,100 for the PLA block and 40,400 for the PVBTMS block. This result well coincides with the compositional ratio between both blocks determined from a peak integrated value ratio of ¹H-NMR.

### EXAMPLE 1

In 60 g of propylene glycol monomethyl ether acetate (PGMEA) were dissolved 3 g of the block copolymer (PMMA-b-PTMSPMA) obtained in SYNTHESIS EXAMPLE 1 and 80 mg of triphenylsulfonium trifluoromethanesulfonate, and the resultant solution was filtered through a filter having a pore size of 0.1 μm, thereby obtaining Photosensitive Composition 1 according to the present invention.

The thus-obtained composition was applied on to a silicon wafer by a spin coating method and heated for 2 minutes at 90° C. on a hot plate to conduct soft bake. After the thus-formed coating film was then exposed to i line as irradiation light through a mask, the coating film was heated for 90 seconds at 100° C. to conduct PEB. This film was developed with isopropyl alcohol/toluene (volume ratio 1:1) to remove non-exposed portions, thereby obtaining a negative pattern. This sample was then annealed for 3 hours at 180° C. under a nitrogen atmosphere in an oven to form a micro phase separation structure. The thus-treated coating film was heated to 550° C. at a rate of 10° C./min and annealed for 2 hours at 550° C. as it is. The thus-obtained film was observed through a scanning electron microscope (SEM). As a result, it was confirmed that this film was a porous silica film that spherical pores having a diameter of 15 nm were made in a 2.0-μm L/S lithographic pattern, and a spherical pattern based on the micro phase separation structure was formed in the lithographic pattern.

### EXAMPLE 2

In 80 g of ethyl cellosolve acetate were dissolved 3 g of the block copolymer (PMMA-b-PTMSPMA) obtained in SYNTHESIS EXAMPLE 2, 50 mg of triphenylsulfonium hexafluoroantimonate and 0.6 g of tetramethoxysilane, and the resultant solution was filtered through a filter having a pore size of 0.1 μm, thereby obtaining Photosensitive Composition 2 according to the present invention. The thus-obtained composition was used to form a pattern in accordance with the same process as in EXAMPLE 1. With respect to the thus-obtained film, a 2.0-μm L/S lithographic pattern was observed through the SEM in the same manner as in EXAMPLE 1. As a result, it was observed that voids of a cylindrical periodic structure having a diameter of 25 nm were formed in the lithographic pattern to confirm a silica nano-structured material in which a pattern based on the micro phase separation structure was formed in the lithographic pattern.

### EXAMPLE 3

In 100 g of PGMEA were dissolved 5 g of the block copolymer (PEG-b-PTMSPMA) obtained in SYNTHESIS EXAMPLE 3, 80 mg of triphenylsulfonium hexafluoroantimonate and 0.2 g of tributoxyaluminum, and the resultant solution was filtered through a filter having a pore size of 0.1 μm, thereby obtaining Photosensitive Composition 3. A pattern was then formed in accordance with the same process as in EXAMPLE 1 except that the temperature in the final annealing step was changed from 550° C. to 450° C. With respect to the thus-obtained film, a 2.0-μm L/S lithographic pattern was observed through the SEM in the same manner as in EXAMPLE 1. As a result, it was observed that voids of a gyroid bi-continuous structure having a diameter of 15 nm were formed in the lithographic pattern to confirm a silica-alumina hybrid nano-structured material in which a pattern based on the micro phase separation structure was formed in the lithographic pattern.

### EXAMPLE 4

In 90 g of PGMEA were dissolved 5 g of the block copolymer (PEG-b-PTMSPMA) obtained in SYNTHESIS EXAMPLE 3, 80 mg of triphenylsulfonium hexafluoroantimonate and 1.0 g of tetramethoxysilane, and the resultant solution was filtered through a filter having a pore size of 0.1 μm, thereby obtaining Photosensitive Composition 4. A pattern was then formed in accordance with the same process as in EXAMPLE 3. With respect to the thus-obtained film, a 2.0-μm L/S lithographic pattern was observed through the SEM in the same manner as in EXAMPLE 1. As a result, it was observed that voids of a gyroid bi-continuous structure having a diameter of 15 nm were formed in the lithographic pattern to confirm a silica nano-structured material in which a pattern based on the micro phase separation structure was formed in the lithographic pattern.

### EXAMPLE 5

In 100 g of PGMEA were dissolved 5 g of the block copolymer (PSt-b-PVBTMS) obtained in SYNTHESIS EXAMPLE 4, 120 mg of triphenylsulfonium trifluoromethanesulfonate and 1.0 g of tetraethoxysilane, and the resultant solution was filtered through a filter having a pore size of 0.1 μm, thereby obtaining Photosensitive Composition 5 according to the present invention. A pattern was then formed in accordance with the same process as in EXAMPLE 1 except that the temperature in the final annealing step was changed from 550° C. to 600° C. With respect to the thus-obtained film, a 2.0-μm L/S lithographic pattern was observed through the SEM in the same manner as in EXAMPLE 1. As a result, it was observed that voids of a cylindrical periodic structure having a diameter of 25 nm were formed in the lithographic pattern to confirm a silica nano-structured material in which a pattern based on the micro phase separation structure was formed in the lithographic pattern.

### EXAMPLE 6

Photosensitive Composition 4 obtained in EXAMPLE 4 was used, applied on to a silicon wafer by a spin coating method and heated for 2 minutes at 90° C. on a hot plate to conduct soft bake. After the whole surface of the thus-formed coating film was then directly exposed to i line as irradiation light through no mask, the coating film was heated for one minute at 100° C. to conduct PEB. After this sample was placed in an oven without conducting development to conduct annealing for 3 hours at 180° C. under a nitrogen atmosphere, the thus-treated coating film was heated to 550° C. at a rate of 10° C./min and annealed for 2 hours at 550° C. as it is. The thus-obtained film was observed through the SEM. As a result, it was confirmed that this film was a porous silica film in which voids of a gyroid bi-continuous structure having a diameter of 15 nm were formed in the whole surface of the film.

The dielectric constant of this film was then determined by forming an Al electrode on the film by a vapor deposition method, measuring the capacity of the capacitor formed by the Al electrode and the silicon wafer and calculating out the dielectric constant from the thickness of the film and the area of the Al electrode. The capacity was measured to be 100 kHz using an impedance analyzer. As a result, the dielectric constant was a low value of 2.1.

### EXAMPLE 7

This example uses a block copolymer, in which a segment containing no alkoxysilyl group is composed of a polyether type polymer. In 90 g of PGMEA were dissolved 5 g of the block copolymer (PEG-b-PTMSPMA) obtained in SYNTHESIS EXAMPLE 5, 80 mg of triphenylsulfonium hexafluoroantimonate and 1.0 g of tetramethoxysilane, and the resultant solution was filtered through a filter having a pore size of 0.1 μm, thereby obtaining Photosensitive Composition 6. A pattern was then formed in accordance with the same process as in EXAMPLE 4. With respect to the thus-obtained film, a 2.0-μm L/S lithographic pattern was observed through the SEM in the same manner as in EXAMPLE 1. As a result, it was observed that voids of a gyroid bi-continuous structure having a diameter of 15 nm were formed in the lithographic pattern to confirm a silica nano-structured material in which a pattern based on the micro phase separation structure was formed in the lithographic pattern.

### EXAMPLE 8

This example uses a block copolymer, in which a segment containing no alkoxysilyl group is composed of a polyester type polymer. In 100 g of PGMEA were dissolved 3 g of the block copolymer (PLA-b-PVBTMS) obtained in SYNTHESIS EXAMPLE 6, 90 mg of 2-(4-chlorophenyl)-4,6-bis(trichloromethyl)-s-triazine and 0.6 g of tetraethoxysilane, and the resultant solution was filtered through a filter having a pore size of 0.1 μm, thereby obtaining Photosensitive Composition 7. A pattern was then formed in accordance with the same process as in EXAMPLE 1 except that the temperature in the final annealing step was changed from 550° C. to 400° C. With respect to the thus-obtained film, a 2.0-μm L/S lithographic pattern was observed through the SEM in the same manner as in EXAMPLE 1. As a result, it was observed that spherical voids having a diameter of 15 nm were formed in the lithographic pattern to confirm a silica nano-structured material in which a pattern based on the micro phase separation structure was formed in the lithographic pattern.

### EXAMPLE 9

Photosensitive Composition 6 obtained in EXAMPLE 7 was used, applied on to a silicon wafer by a spin coating method and heated for 2 minutes at 90° C. on a hot plate to conduct soft bake. After the whole surface of the thus-formed coating film was then directly exposed to i line as irradiation light through no mask, the coating film was heated for one minute at 100° C. to conduct PEB. After this sample was placed in an oven without conducting development to conduct annealing for 3 hours at 180° C. under a nitrogen atmosphere, the thus-treated coating film was heated to 550° C. at a rate of 10° C./min and annealed for 2 hours at 550° C. as it is. The thus-obtained film was observed through the SEM. As a result, it was confirmed that this film was a porous silica film in which voids of a gyroid bi-continuous structure having a diameter of 15 nm were formed in the whole surface of the film.

The dielectric constant of this film was then determined by forming an Al electrode on the film by a vapor deposition method, measuring the capacity of the capacitor formed by the Al electrode and the silicon wafer and calculating out the dielectric constant from the thickness of the film and the area of the Al electrode. The capacity was measured to be 100 kHz using an impedance analyzer. As a result, the dielectric constant was a low value of 2.1.

Since the porous inorganic nano-structured materials according to the present invention can be suitably used as low-dielectric constant insulation films for semiconductor devices, multi-layer wiring boards and the like, the utility value thereof is extremely high.

This application claims priority from Japanese Patent Application No. 2005-073255 filed Mar. 15, 2005, which is hereby incorporated by reference herein.

What is claimed is:

1. A photosensitive composition comprising:
(A) a block copolymer containing a segment composed of an alkoxysilyl-group-containing monomer as a repeating unit, and
(B) a photosensitive decomposition agent, wherein the polydispersity index (Mw/Mn) of the block copolymer is 1.8 or lower.

2. The photosensitive composition according to claim 1, which further comprises: (C) a compound capable of crosslinking the block copolymer (A) in the presence of an acid or base.

3. The photosensitive composition according to claim 1, wherein the photosensitive decomposition agent is a photosensitive acid generator or photosensitive base generator.

4. The photosensitive composition according to claim 1, wherein in the block copolymer containing the segment composed of the alkoxysilyl-group-containing monomer as the repeating unit, a main chain of a segment containing no alkoxysilyl group contains an ester bond.

5. The photosensitive composition according to claim 1, wherein in the block copolymer containing the segment composed of the alkoxysilyl-group-containing monomer as the repeating unit, a main chain of a segment containing no alkoxysilyl group contains an ether bond.

6. A process for producing a structured material containing a micro phase separation structure, which comprises the steps of:
(1) a step of exposing a film formed of a composition comprising: (A) a block copolymer containing a segment composed of an alkoxysilyl-group-containing monomer as a repeating unit, whose polydispersity index (Mw/Mn) is 1.8 or lower, and (B) a photosensitive decomposition agent,
(2) a step of developing the film after the exposing step, and
(3) a step of heating the film after the developing step.

7. The production process according to claim 6, wherein the step (2) is conducted after the step (3).

8. The production process according to claim 6, which further comprises a step of heating the film at a temperature higher than the glass transition temperature of the block copolymer after the steps (1) to (3).
